(19) United States
(12) Patent Application Publication
(10) Pub. No.: US 2007/0029148 A1
(43) Pub. Date: Feb. 8, 2007

(54) Caliper brake pad clip

(75) Inventor: Philip N. Jedele, Ypsilanti, MI (US)

Correspondence Address: HARNESS, DICKEY & PIERCE, P.L.C., P.O. BOX 828, BLOOMFIELD HILLS, MI, 48303, US

(73) Assignee: Akebono Corporation North America, Farmington Hills, MI (US)

(21) Appl. No.: 11/199,020

(22) Filed: Aug. 8, 2005

(51) Int. Cl. F16D 65/38

(52) U.S. Cl. 188/250 G; 188/73.36

(57) ABSTRACT

A pad clip positioned between a brake pad and a support bracket in a caliper assembly, the pad clip including a first portion and a second portion. The first portion provides an abutment surface for the brake pad and retains the brake pad in a guide channel of the support bracket. The first portion includes a first wall that is continuous with a second wall along a lateral edge of the first wall. The second wall is substantially perpendicular to the first wall. A third wall is continuous with the second wall along a lateral edge of the second wall and is substantially parallel to the first wall. At least one of the first wall, the second wall and the third wall act as a first abutment for the brake pad. A second portion provides an abutment surface for the brake pad. The second portion includes a fourth wall parallel to the third wall. The fourth wall is continuous with the third wall along a longitudinal end of the third wall. A fifth wall is continuous with the fourth wall along a lateral edge of the fourth wall. The fifth wall is substantially perpendicular to the fourth wall. At least one of the fourth wall and the fifth wall acts as a second abutment for the brake pad.

### FIELD OF THE INVENTION

The present invention relates to brake caliper assemblies and, more particularly, to brake pad clips to retain brake pads in position on a support bracket of the brake caliper assembly.

### BACKGROUND OF THE INVENTION

Various designs of caliper brake pad clips are stamped from a flat metal sheet of material and bent into various configurations. The brake pad clips provide a friction abutment surface, as well as a barrier to prevent corrosion between the brake pad and the caliper assembly. Certain requirements thus certain designs may be relatively complicated and difficult to manufacture. Improper manufacturing of the clips may increase sliding resistance associated with the brake pad. The increased resistance may reduce a life of the brake pad lining and may increase disc thickness variation, which may cause vibration.

Accordingly, designers strive to improve the art and provide better brake pad clips. Brake pad clips which are easier to manufacture and maintain may reduce costs, which is beneficial in the industry. Thus, it would be desirable to produce a brake pad clip that provides the necessary features while reducing costs and providing ease of manufacturability.

### SUMMARY OF THE INVENTION

The present invention provides the art with a pad clip which reduces the amount of material needed to manufacture it. The present invention provides a pad clip which requires less bending of the material to provide the inventive pad clip.

According to a first embodiment of the invention, a brake pad clip for a caliper assembly comprises a first portion to retain and abut the brake pad in a guide channel of the caliper support bracket. The first portion has a first wall which is continuous with a second wall. The second wall is continuous along a lateral edge of the first wall. The second wall is substantially perpendicular to the first wall. A third wall is continuous with the second wall along the lateral edge of the second wall. The third wall is parallel to the first wall. The first wall, second wall and/or third wall act as an abutment for a brake pad.

A second portion provides an abutment surface for the brake pad. The second portion includes a fourth wall parallel to the third wall. The fourth wall is continuous with the third wall along a longitudinal edge of the third wall. A fifth wall is continuous with the fourth wall along the lateral edge of the fourth wall. The fifth wall is substantially perpendicular to the fourth wall. The fourth wall and/or the fifth wall act as an abutment for the brake pad.

The first wall may include a P-shaped spring mechanism. A connecting member extends from the longitudinal edge of the third and fourth walls and joins the walls. The connecting member has a desired length such that as it is bent, a gap is formed between the third and fourth walls enabling a guide mechanism of a support bracket to be positioned in the gap. The connecting member is arcuate. Also, the second and fifth wall members include guide tabs that extend therefrom. The first wall includes positioning tabs that extend therefrom.

According to a second embodiment of the present invention, a caliper assembly comprises a caliper body and a support bracket. A pair of brake pads is slidably coupled with the support bracket and the caliper body to brake a rotor. A pair of pad clips is positioned on the support bracket between the support bracket and the brake pads. The pad clips each comprise a first portion and a second portion to abut the brake pad. The first portion also retains the brake pad in a guide channel of the caliper support bracket. The first portion has a first wall which is continuous with a second wall. The second wall is continuous along a lateral edge of the first wall. The second wall is substantially perpendicular to the first wall. A third wall is continuous with the second wall along the lateral edge of the second wall. The third wall is parallel to the first wall. The first wall, the second wall and/or the third wall acts as an abutment for the pair of brake pads.

The second portion includes a fourth wall parallel to the third wall acting as a second abutment. The fourth wall is continuous with the third wall along a longitudinal edge of the third wall. A fifth wall is continuous with the fourth wall along the lateral edge of the fourth wall. The fifth wall is substantially perpendicular to the fourth wall. The first wall may include a P-shaped spring mechanism. A connecting member is on the longitudinal edge of the third and fourth wall. The connecting member has a desired length such that as it bent, a gap is formed between the third and fourth walls enabling a guide mechanism of the support bracket to be positioned in the gap. The connecting member is arcuate. Also, the second and fifth wall members include positioning tabs.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a caliper assembly in accordance with the present invention;

FIG. 2 is a partial perspective view of a support bracket a brake pad clips attached thereto in accordance with the present invention;

FIG. 3 is a perspective of one of the pad clips in accordance with the present invention; and

FIG. 4 is a cross-sectional view of the support bracket and the brake pad clip in accordance with the present invention.

### DETAILED DESCRIPTION OF THE VARIOUS EMBODIMENTS

The following description of the various embodiments is merely exemplary in nature and is in no way intended to limit the invention, its application, or uses.

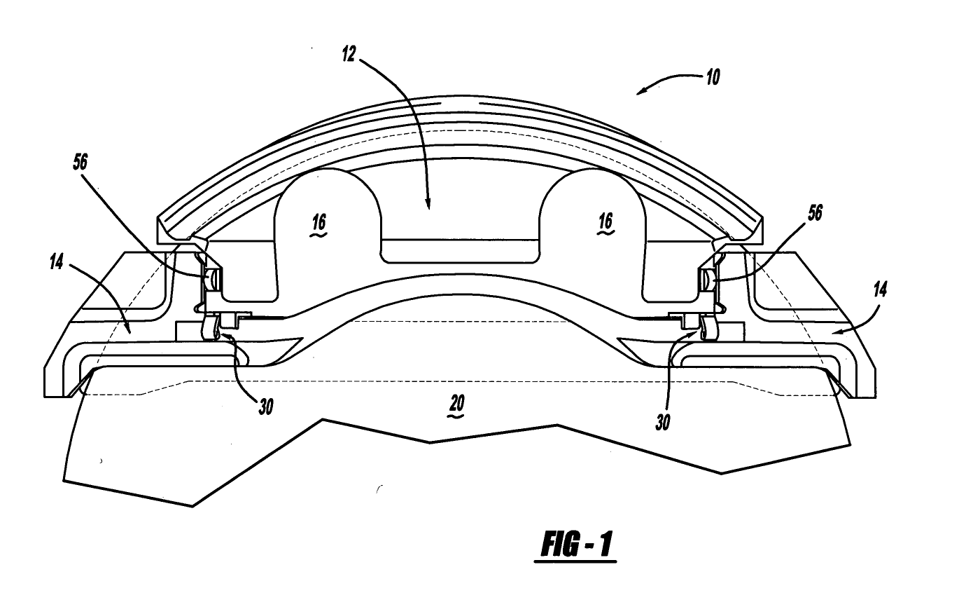

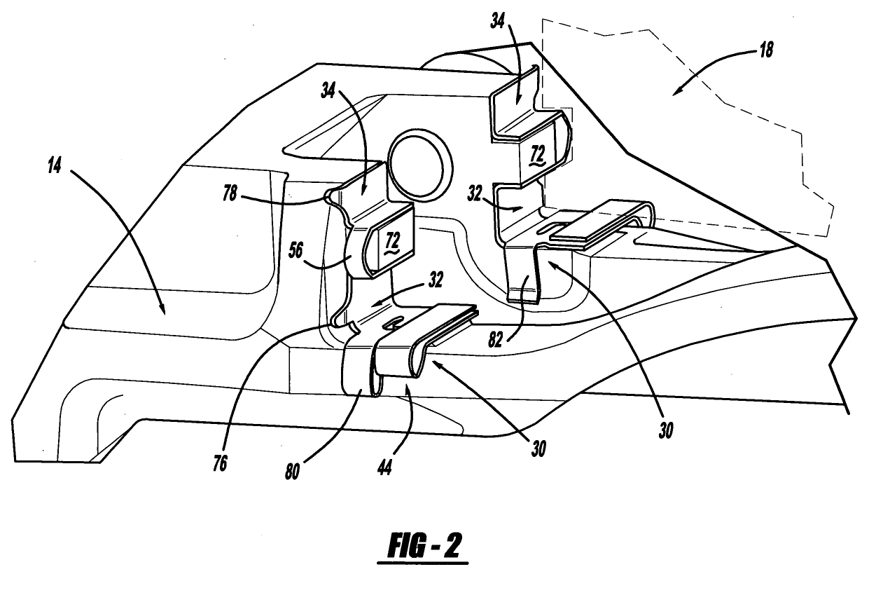

With reference to FIGS. 1 and 2, a caliper assembly is illustrated and designated with the reference numeral 10. The caliper assembly includes a caliper body 12 and a support bracket 14. An outboard brake pad 16 and an inboard brake pad 18 (illustrated in phantom in FIG. 2) are positioned along rails of the support bracket 14. A rotor 20 is positioned between the brake pads. The caliper assembly 10 clamps the brake pads 16 and 18 against the rotor 20 to slow, for example, a vehicle (not shown).

A brake pad clip 30 is positioned on the support bracket 14 to provide a friction and abutment surface for the brake pads 16 and 18. The pad clip 30 also provides corrosion resistant between the brake pads 16 and 18 and the caliper support 14 and body 12.

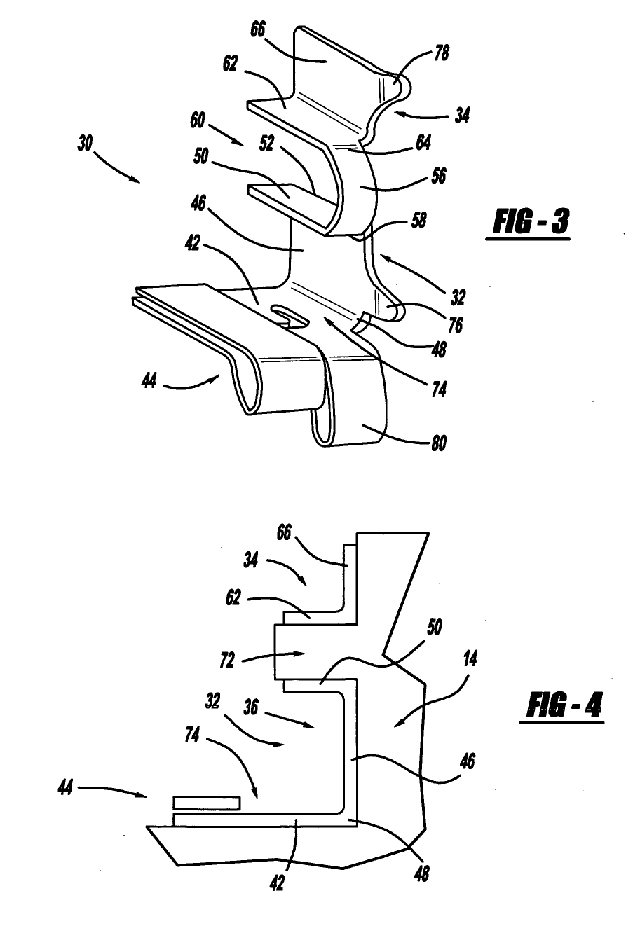

With reference to FIGS. 3 and 4, the pad clips 30 include a first portion 32 and a second portion 34. The first portion 32 may also be a retaining portion that retains the pad clips 30 in a support channel 36. The first portion 32 and a second portion 34 provide an abutment for the brake pads 16 and 18.

The first portion 32 includes a first wall 42. The first wall 42 may include a P-shaped spring 44 that provides additional biasing force to load the brake pads 16 or 18 within the channel 36. A second wall 46 extends from a side or lateral edge 48 of the first wall 42. The second wall 46 is continuous with the first wall 42. Also, the second wall 46 is substantially perpendicular to the first wall 42. A third wall 50 is continuous with the second wall 46 along its side or its lateral edge 52. The third wall 50 is bent with respect to the second wall 46 such that it extends over the first wall 42. The third wall 50 is substantially parallel to the first wall 42. The first wall 42, the second wall, 46 and/or the third wall 50 provide an abutment surface 54 for the brake pads 16 and 18. The third wall 50 includes a connecting member 56 at its longitudinal end 58. The second wall 46 may be formed at other angles acute or obtuse (i.e., not perpendicular) to the first wall 42 and/or the third wall 50.

The connecting member 56 has a desired arcuate shape as well as length to provide a gap 60 between the third wall 50 and a fourth wall 62. The connecting member 56 is continuous with the longitudinal end 58 of the third wall 50, as well as with a longitudinal end 64 of the fourth wall 62. The connecting member 56 may be stamped such that it is substantially perpendicular to the third wall 50; however, an arcuate bend is preferred.

The fourth wall 62 is substantially parallel with the third wall 50. A fifth wall 66 is continuous along a side or a lateral edge 68 of the fourth wall 62. The fifth wall 66 is substantially perpendicular to the fourth wall 62. The fourth wall 62 and/or the fifth wall 66 provide an abutment surface 70 for the brake pads 16 or 18. The connecting member 56 enables the third and fourth walls 50 and 62 to be substantially parallel and provides tighter tolerance controls during manufacturing to provide the desired parallelism along the abutment surfaces 54, 70. The fifth wall 66 may be formed at other angles acute or obtuse (i.e., not perpendicular) to the fourth wall 62.

The gap 60 formed between the third wall and fourth wall 50 and 62 provides an area for a guide finger 72 of the support bracket 14 to project into the gap 60. The guide finger 72 provides a stationary surface for the walls 50 and 62, which, in turn, provide the abutment surfaces 54 and 70. Thus, the guide finger 72 enables the first portion 32 or the retaining portion 32 to have a spring-like bias between a base 74 of the channel 36 and the guide finger 72 to retain the brake pad clip 30 within the channel 36. The guide finger 72 also provides a shelf for the third and fourth walls 50, 62 to enable the abutment surfaces 54, 70 to be stationary and fixed relative to the guide finger 72.

Guide tabs 76 and 78 project from the second and fifth walls 46 and 66. The guide tabs 76 and 78 and the connecting member 56 may provide a mechanism to make installation of the brake pads 16 and 18 easier. Position tangs 80 and 82 project from the first wall 42 and may hold and/or position the pad clip 30 with the support bracket 14.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A pad clip positioned between a brake pad and a support bracket in a caliper assembly, the pad clip comprising:
a first portion for providing an abutment surface for the brake pad and retaining the brake pad in a guide channel of a caliper, said first portion having a first wall, said first wall continuous with a second wall along a lateral edge of said first wall, said second wall substantially perpendicular to said first wall, a third wall continuous with said second wall along a lateral edge of said second wall and being substantially parallel to said first wall, at least one of said first wall, said second wall and said third wall acting as a first abutment for the brake pad; and
a second portion for providing an abutment surface for the brake pad, said second portion including a fourth wall parallel to said third wall, said fourth wall continuous with said third wall along a longitudinal end of said third wall, a fifth wall continuous with said fourth wall along a lateral edge of said fourth wall, said fifth wall substantially perpendicular to said fourth wall, at least one of said fourth wall and said fifth wall acting as a second abutment for the brake pad.

2. The pad clip according to claim 1, wherein said first wall includes a P-shaped spring mechanism.

3. The pad clip according to claim 1, wherein a connecting member is on the longitudinal end of said third and fourth walls.

4. The pad clip according to claim 3, wherein said connecting member has a desired length such that a gap is formed between said third and fourth walls enabling a portion of the support bracket to be positioned in the gap.

5. The pad clip according to claim 4, wherein said connecting member is arcuate.

6. The pad clip according to claim 1, wherein said second and fifth walls include guide tabs.

7. A caliper assembly comprising:
a caliper body slidably coupled to a support bracket;
a pair of brake pads slidably coupled with said support bracket, said caliper body adapted to clamp the brake pads against a rotor; and
two pairs of pad clips positioned on said support bracket between said support bracket and said brake pads, each of said pad clips having a first portion and a second portion for abutting one of said brake pads, said first portion retaining one of said brake pads in a guide channel of said support bracket, said first portion having a first wall that extends from and is continuous with a second wall along a lateral edge of said first wall, a third wall extends from and is continuous with said second wall along a lateral edge of said second wall, said second portion including a fourth wall substantially parallel to said third wall, said fourth wall continuous with said third wall along a longitudinal end of said third wall, a fifth wall extends from and is continuous with said fourth wall along a lateral edge of said fourth wall.

8. The caliper assembly according to claim 7, wherein said first wall includes a P-shaped spring mechanism.

9. The caliper assembly according to claim 7, wherein a connecting member is on the longitudinal end of said third and fourth walls.

10. The caliper assembly according to claim 9, wherein said connecting member has a desired length such that a gap is formed between said third and fourth walls enabling a guide mechanism of the caliper to be positioned in the gap.

11. The caliper assembly according to claim 10, wherein said connecting member is arcuate.

12. The caliper assembly according to claim 7, wherein said second and fifth walls include guide tabs.

13. The caliper assembly of claim 7 wherein said third wall is substantially parallel to said fourth wall.

14. The caliper assembly of claim 13 wherein said first wall is parallel to said third wall.

15. The caliper assembly of claim 7 wherein said second wall and said fifth wall are parallel.

16. The caliper assembly of claim 7 wherein at least one of
said first wall is substantially perpendicular to said second wall,
said second wall is substantially perpendicular to said third wall, and
said fourth wall is substantially perpendicular to said fifth wall.

17. The caliper assembly of claim 7 wherein at least one of
said first wall forms an acute or an obtuse angle with said second-wall,
said second wall forms an acute or an obtuse angle with said third wall, and
said fourth wall forms an acute or an obtuse angle with said fifth wall.
